(19) United States
(12) Patent Application Publication
(10) Pub. No.: US 2021/0094042 A1
(43) Pub. Date: Apr. 1, 2021

(54) SHREDDER BLADE ASSEMBLY

(71) Applicant: Eco Green Equipment, LLC, North Salt Lake, UT (US)

(72) Inventors: Ted Bushman Rogers, West Haven, UT (US); Michael Bradley Swenson, North Salt Lake, UT (US)

(73) Assignee: Eco Green Equipment, LLC, North Salt Lake, UT (US)

(21) Appl. No.: 17/121,116

(22) Filed: Dec. 14, 2020

Related U.S. Application Data
(63) Continuation of application No. 14/282,093, filed on May 20, 2014, now Pat. No. 10,864,523.

(51) Int. Cl. B02C 18/18; B02C 18/14

(52) U.S. Cl. CPC B02C 18/18; B02C 2210/02; B02C 18/184; B02C 18/142

(57) ABSTRACT

A shredder blade assembly is disclosed having a rotor configured to be mounted on a rotating shaft, the rotor having opposing faces with a plurality of angled knife receptacles and a plurality of knife inserts mounted within the plurality of knife receptacles. Each knife insert has two opposing faces and each opposing face comprises three cutting edges such that each knife insert has six cutting edges. Only one of the cutting edges is exposed at an outer peripheral edge of the shredder blade assembly during use. The knife inserts are configured to be removed, rotated (and flipped as needed), and re-mounted within the plurality of knife receptacles to expose another of the cutting edges at the outer peripheral edge of the shredder blade assembly. The knife insert may be triangular and mounted to expose one vertex to create a plurality of tooth/hook projections.

### PRIORITY CLAIM

This application claims the priority and benefit of U.S. Pat. No. 10,864,523, filed on May 20, 2014. U.S. Pat. No. 10,864,523 is incorporated by reference in its entirety.

### TECHNICAL FIELD

This disclosure relates to a shredder blade assembly that includes interchangeable knife inserts with six cutting edges.

### BACKGROUND

Industrial shredding machines are used to shred or reduce objects into smaller pieces for reuse or recycle. Shredding machines are commonly rotary shredders comprising pairs of counter-rotating, intermeshing, serrating and shearing blade assemblies or cutting wheels. The blade assemblies are mounted on parallel rotating shafts. The number of pairs of parallel blade assemblies on a single shaft can vary. A larger number of blade assemblies will increase the capacity of the shredder. The parallel blade assemblies are separated by spacers to allow intermeshing of another set of parallel blade assemblies on another shaft.

In the shredding zone, the tire or article to be shredded encounters the outer periphery of the counter-rotating blade assemblies. After continuous shredding for a period of time, the outer periphery of the blade assembly becomes worn by the toughness of tires or articles being shredded. These cutting or shearing surfaces would need to be resurfaced. The problem of resurfacing cutting wheels has been addressed by using a modular construction of blade assemblies comprising a rotor structure upon which a plurality of cutting and shearing surfaces are attached. The outer peripheral contact region of a blade assembly is removed and replaced instead of removing the entire wheel from its shaft for repair. This is done by removing individual cutting and shearing surfaces, or knives, from the rotor.

It will be appreciated that there is a need in the art for shredder blade assemblies that can be quickly and efficiently maintained to reduce equipment down-time and expensive repair on industrial shredders.

It will further be appreciated that there is a need in the art for shredder blade assemblies with replaceable knife inserts that have a long usable lifespan, thereby lowering maintenance costs.

### SUMMARY OF THE INVENTION

A shredder blade assembly is disclosed that includes a rotor upon which are mounted interchangeable knife inserts.

Each knife insert has six cutting or shearing edges. It may have a triangular or modified-triangular shape. During shredder operation, only one of the six cutting edges is subject to wear. After one cutting edge is worn, the knife insert is rotated 120°, thereby exposing another edge. The knife insert may be rotated to expose the three cutting edges on one side of the knife insert. After all three cutting edges on one side are worn, the entire knife insert is flipped over and rotated as needed to expose three additional cutting edges. The knife inserts are held in place by a symmetrical hole pattern that enables correct placement and bolting of the knife insert onto the rotor despite being rotated and flipped.

The knife inserts are preferably fabricated of a high alloy steel and/or tool steel. The knife inserts may optionally be coated with wear resistant surface coatings. The knife inserts may optionally be fabricated with carbide wear edges.

When the knife insert is inserted onto the rotor its triangle shape and the way it is inserted onto the rotor creates a positive angle tooth/hook, much like a saw tooth, that pulls material through the opposing cutting edges more efficiently than other insert types.

In one non-limiting embodiment, the knife inserts are staggered on each side of the rotor so that the teeth/hooks are offset to create a smoother flow of material into the blade assembly as they cut, shear, and shred the material. Without being bound by theory, it is believed that the smoother flow of material into the blade assembly produces less stress and wear on the gears and motors that drive the shredder.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIGS. 1A, 1B, and 1C are front perspective, front, and side views, respectively, of a shredder blade assembly within the scope of the disclosed invention.

FIGS. 2A and 2B are front and top plan views, respectively, of shredder blade assemblies mounted on shafts.

FIGS. 3A, 3B, and 3C are front perspective, front, and side views, respectively, of a rotor within the scope of the disclosed invention.

FIG. 4 is an enlarged view of region A3 identified in FIG. 3B.

FIG. 5 is an enlarged partial cross-sectional view taken along line B3-B3 of FIG. 4.

FIGS. 6A, 6B, and 6C are a front perspective, a front, and a cross-sectional view (taken along line C4-C4 of FIG. 6B), respectively, of a knife insert within the scope of the disclosed invention.

FIGS. 7A, 7B, and 7C are a front perspective, a front, and a cross-section view (taken along line A-A of FIG. 7B), respectively, of a blade assembly spacer within the scope of the disclosed invention.

### DETAILED DESCRIPTION OF THE INVENTION

The present embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the shredder blade assembly, is not intended to limit the scope of the invention, as claimed, but is merely representative of present embodiments of the invention.

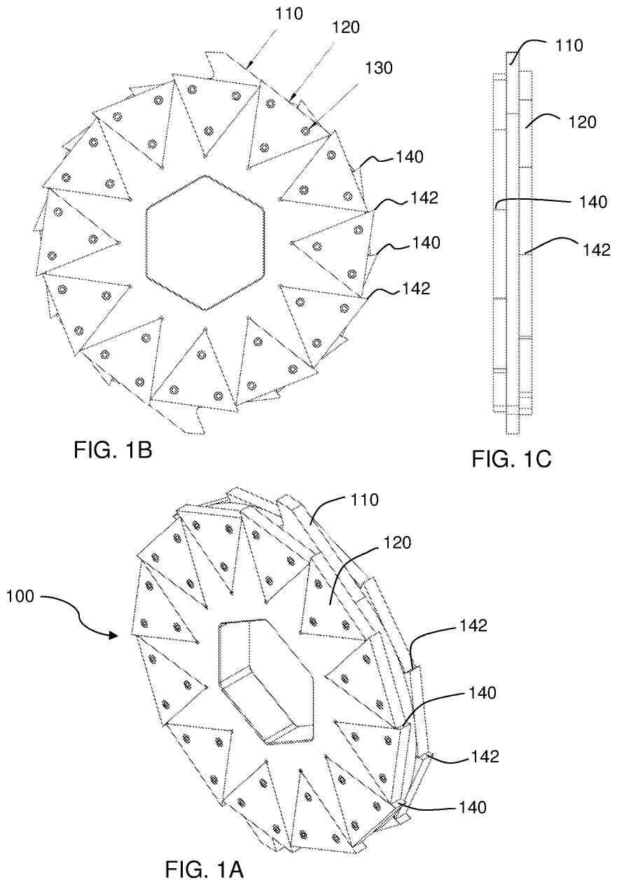

The disclosed invention relates to a shredder blade assembly having interchangeable knife inserts. One non-limiting embodiment of a shredder blade assembly 100 is shown in FIGS. 1A, 1B, and 1C. The shredder blade assembly includes a rotor 110 upon which are mounted a plurality of knife inserts 120. In the illustrated embodiment, 12 knife inserts 120 are mounted on one side of the rotor 110 and 12 other knife inserts 120 are mounted on the opposite side of the rotor 110. It will be appreciated that the number of knife inserts mounted on each rotor may be varied. Thus, the invention is not limited to the specific number of knife inserts shown in the Figures.

The knife inserts 120 are mounted to the rotor using suitable fasteners 130. The fasteners 130 may be screws, such as socket head cap screws. As shown, each rotor may be mounted using screws in a symmetrical screw hole pattern. A symmetrical hole pattern enables correct placement and bolting of the knife insert 120 onto the rotor 110 despite being rotated and flipped. In one disclosed embodiment, three fasteners 130 are used to mount each knife insert 120. In another embodiment, a single centrally located fastener may be used to mount each knife insert 120. It is understood that precise number of holes and fasteners used may vary.

The disclosed knife inserts 120 are preferably made in the shape of an equilateral triangle. They are mounted in a way to expose one vertex of the triangle to create a positive angle tooth/hook 140, 142 much like a saw tooth, that pulls material through the opposing cutting edges more efficiently than other shredder blade insert types. It will be understood that the shape of the knife inserts may be modified to another polygonal shape and still provide six cutting and shearing edges. For instance, the knife insert may have a modified triangular shape, such as a hexagonal shape. As used herein, a modified triangular shape includes a shape that still has three dominant sides or edges, but may not be “technically” a triangle. A modified triangular shape that is hexagonal may be achieved by removing a portion of each vertex of the equilateral triangle. The precise angle and amount removed from each vertex may vary.

In one non-limiting embodiment, the knife inserts are staggered on the each side of the rotor so that the teeth/hooks 140, 142 are offset to create a smoother flow of material into the shredder blade assemblies as they cut, shear, and shred the material. Without being bound by theory, it is believed that the smoother flow of material into the blade assembly produces less stress and wear on the gears and motors that drive the shredder.

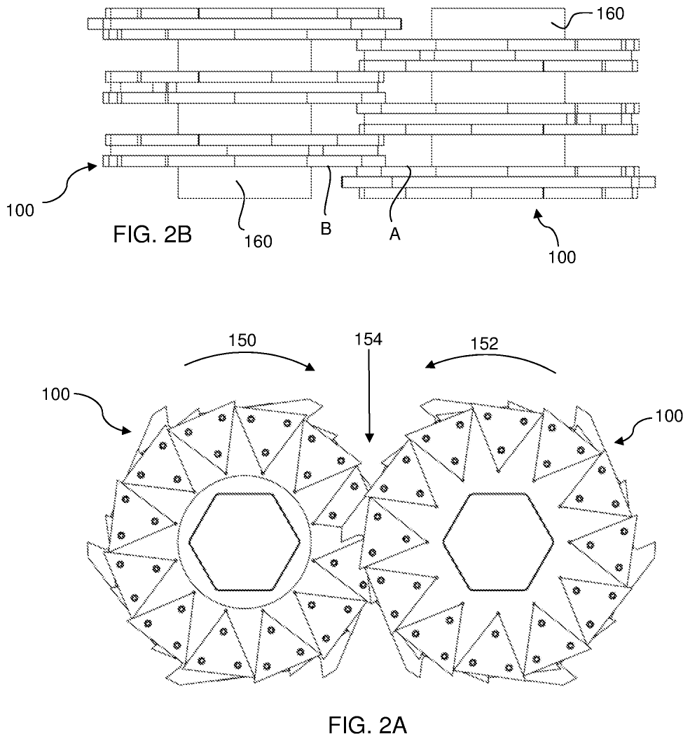

Rotary shredders comprise pairs of counter-rotating, intermeshing, serrating and shearing blade assemblies. FIG. 2A shows a front view and 2B shows a top view of shredder blade assemblies 100 mounted on parallel rotatable shafts. The number of pairs of parallel blade assemblies on a single shaft can vary. A larger number of blade assemblies will increase the capacity of the shredder. It will be appreciated that the number of blade assemblies 100 shown in FIG. 2B is for illustration purposes. The actual number of blade assemblies 100 in a working rotary shredder would typically be greater than the number illustrated in FIG. 2B.

Each shaft rotates in an opposite direction, as shown by arrows 150, 152 so that the article to be shredded is drawn into a shredding zone indicated by arrow 154. Within the shredding zone 154, the exposed outer edge of knife inserts on one blade assembly 100 (identified as “A” in FIG. 2B) contact and interact with the exposed outer edge of knife inserts on the opposed and adjacent blade assembly rotating in the opposite direction (identified as “B” in FIG. 2B). The interacting outer edges cut, shear, or shred the article.

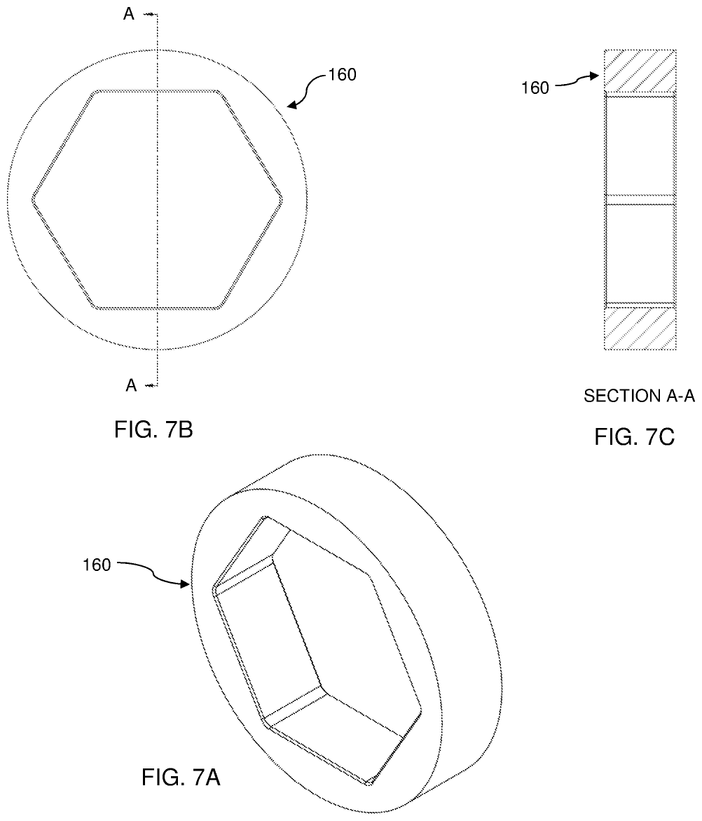

The parallel blade assemblies are separated by spacers 160 to allow proper spacing and intermeshing of an opposing set of parallel blade assemblies on another shaft. The width or thickness of the spacers may vary as needed to ensure that opposing blade assemblies interact to produce the cutting, shearing, or shredding function. A representative example of a blade assembly spacer is shown in FIGS. 7A-7C.

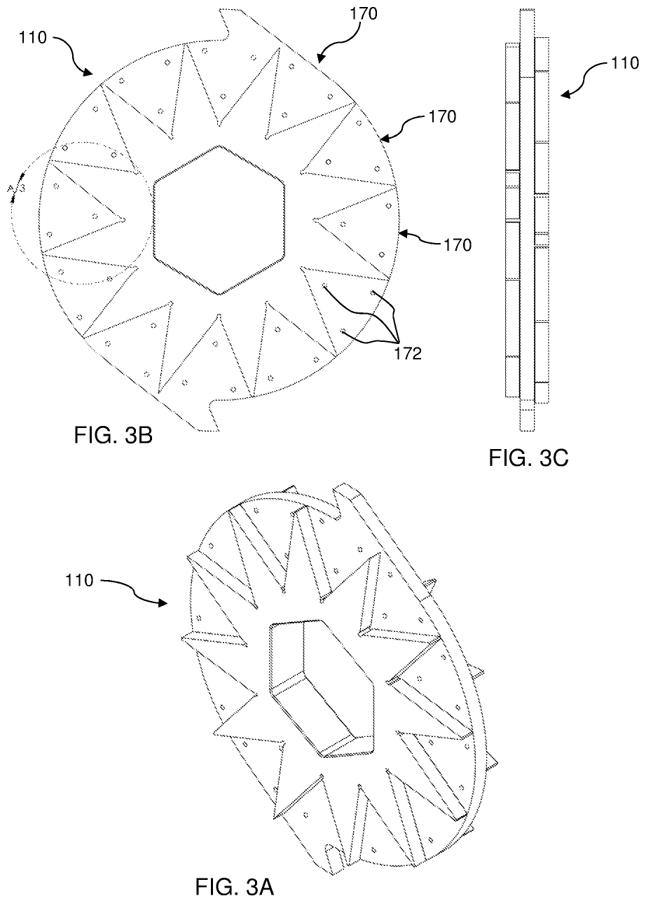

FIGS. 3A-3C illustrate one non-limiting example of a rotor 110 within the scope of the disclosed invention. The rotor 110 is fabricated or machined to include a plurality of knife receptacles 170 sized and configured to receive a plurality of triangular knife inserts mounted on opposite sides of the rotor. While the illustrated embodiment of the rotor 110 may accommodate 12 knife inserts mounted on each side, it is understood that the rotor can be fabricated to accommodate any practical number of knife inserts.

Each knife receptacle includes one or more holes 172 disposed in a symmetrical hole pattern to receive suitable fasteners used to mount a knife insert. As described above, the symmetrical hole pattern enables correct placement and bolting of knife insert onto the rotor 110 despite being rotated and flipped.

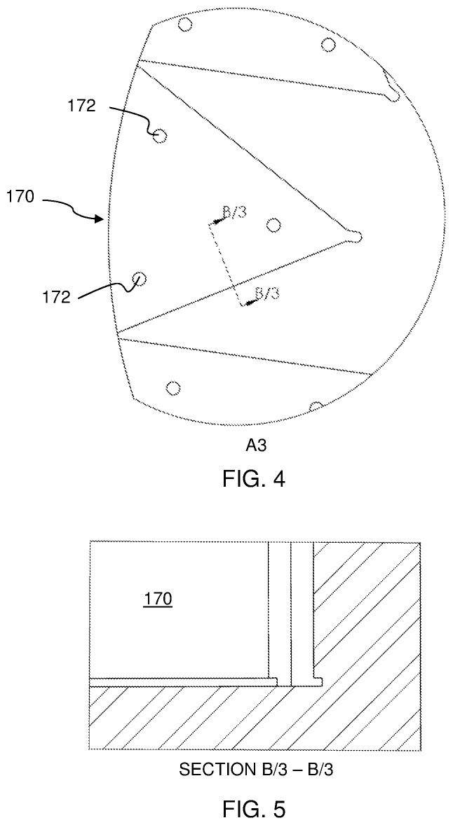

FIG. 4 is an enlarged view of the knife receptacle 170 shown in the region A3 identified in FIG. 3B. FIG. 5 is an enlarged partial cross-sectional view taken along line B3-B3 of FIG. 4.

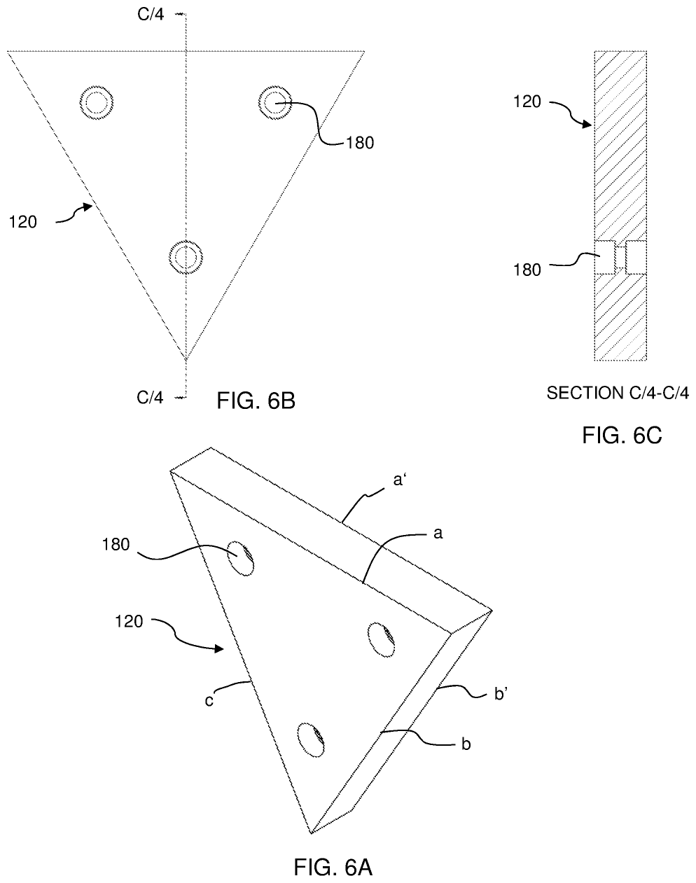

FIGS. 6A-6C show details of a knife insert 120. As described above, each knife insert 120 is triangular shaped, thereby providing six cutting or shearing edges, labelled in FIG. 6A as edges a, b, c on one side and edges a′ and b′ on the opposite side, with edge c′ being hidden in the perspective view by edge c. During shredder operation, only the exposed outer edge of each knife insert is subject to wear. Thus, only one of the six edges is subject to wear during shredder operation. After one cutting edge is worn, the knife insert is removed from the rotor, rotated 120°, and reinstalled to the rotor, thereby exposing another edge. The knife insert 120 is rotated as needed to expose the three cutting edges on one side of the knife insert. After all three cutting edges on one side are worn, the entire knife insert 120 is flipped over and rotated as needed to expose three additional cutting edges.

The ability to use a knife insert with six cutting or shearing edges greatly extends the useful life of the knife insert. This can reduce operating and maintenance costs for the shredder.

The knife inserts 120 are mounted to the rotor by fasteners 130 using holes 180 arranged in a symmetrical hole pattern that enables correct placement and bolting of the knife insert 120 onto the rotor 110 despite being rotated and flipped, as described above.

The knife inserts are preferably fabricated of a high alloy steel and/or hardened tool steel. The knife inserts may optionally be coated with wear resistant surface coatings. In a non-limiting embodiment, the knife inserts are fabricated with carbide wear edges.

While specific embodiments and examples of the present invention have been illustrated and described, numerous modifications come to mind without significantly departing from the spirit of the invention, and the scope of protection is only limited by the scope of the accompanying claims.

1. A shredder blade, comprising:
a rotor comprising:
one or more knife receptacles, and
one or more knife mounting holes; and
one or more knife inserts, the one or more knife inserts being polygonal in shape, and comprising:
one or more mounting holes, and
a cutting edge disposed on the polygonal shaped one or more knife inserts.

2. The shredder blade of claim 1, wherein the rotor further comprises a first face and an opposing second face.

3. The shredder blade of claim 2, wherein the one or more knife receptacles are disposed on the first face and the opposing second face of the rotor.

4. The shredder blade of claim 2, wherein the one or more knife inserts are attached to the first face of the rotor via the knife mounting holes in the rotor and the one or more mounting holes in the knife insert.

5. The shredder blade of claim 4, wherein a fastener attaches the knife insert to the first face of the rotor via the knife mounting holes in the rotor and the one or more mounting holes in the knife insert

6. The shredder blade of claim 1, wherein the one or more knife receptacles are positioned on a first face of the rotor to expose the cutting edge disposed on the one or more knife inserts when the knife insert is attached to the rotor.

7. The shredder blade of claim 6, wherein another of the one or more knife receptacles are positioned on an opposing face of the rotor, which is opposite the first face of the rotor, to expose the cutting edge disposed on the one or more knife inserts when the knife insert is attached to the opposing face of the rotor.

8. The shredder blade of claim 7, wherein the one or more knife receptacles positioned on the first face of the rotor position the knife insert to expose a cutting edge of the knife insert at a position that is staggered from the position of a knife insert attached to the one or more knife receptacles positioned on the opposing face of the rotor.

9. The shredder blade of claim 1, wherein the knife insert includes a plurality of cutting edges.

10. The shredder blade of claim 9, wherein the plurality of cutting edges are disposed along an outer edge of the knife insert.

11. The shredder blade of claim 10, wherein the plurality of cutting edges are disposed along an inside surface of the outer edge of the knife insert.

12. The shredder blade of claim 10, wherein the plurality of cutting edges are disposed along an outside surface of the outer edge of the knife insert.

13. The shredder blade of claim 1, wherein at least one of the polygonal shaped knife inserts are shaped to be received into at least one of the knife receptacles on the rotor.

14. The shredder blade of claim 13, wherein the at least one of the knife receptacles on the rotor is disposed to accept the at least one of the polygonal shaped knife inserts in at least a first position and a second position, the second position being a clockwise or counterclockwise rotation of the knife insert.

15. The shredder blade of claim 13, wherein the at least one of the knife receptacles on the rotor is disposed to accept the at least one of the polygonal shaped knife inserts in a first position and a second position, the second position being a flipped rotation of the knife insert.

16. A shredder machine, comprising,
a first shredder blade, comprising one or more knife receptacles and one or more knife mounting holes;
a second shredder blade, comprising one or more knife receptacles and one or more knife mounting holes;
one or more knife inserts, the one or more knife inserts being polygonal in shape and comprising one or more mounting holes and a cutting edge disposed on the polygonal shaped one or more knife inserts.

17. The shredder machine of claim 16, wherein the first shredder blade and the second shredder blade each include one or more knife receptacles on opposing faces of both the first shredder blade and the second shredder blade.

18. The shredder machine of claim 16, wherein the first shredder blade is mounted on a first shaft and the second shredder blade is mounted on a second shaft.

19. The shredder machine of claim 18, wherein the first shredder blade mounted on the first shaft rotates in a first direction and wherein the second shredder blade mounted on the second shaft rotates in a second direction, opposite the first direction.

20. The shredder machine of claim 19, further comprising a third shredder blade comprising one or more knife receptacles and one or more knife mounting holes mounted on the first shaft and separated from the first shredder blade by a spacer, wherein at least a portion of the second shredder blade is disposed between the first shredder blade and the third shredder blade as the second shredder blade rotates on the second shaft.
